(19) United States
(12) Patent Application Publication
(10) Pub. No.: US 2016/0046142 A1
(43) Pub. Date: Feb. 18, 2016

(54) MULTIFUNCTIONAL MARKING INSTRUMENT

(71) Applicant: ArtSkills, Inc., Bethlehem, PA (US)

(72) Inventor: Stephen P. Dashe, Bethlehem, PA (US)

(21) Appl. No.: 14/826,368

(22) Filed: Aug. 14, 2015

Related U.S. Application Data
(60) Provisional application No. 62/037,161, filed on Aug. 14, 2014.

(51) Int. Cl. B43K 27/08; B43K 8/03; B43K 8/06

(52) U.S. Cl. CPC B43K 27/08; B43K 8/06; B43K 8/03

(57) ABSTRACT

Described herein are marking instruments comprising an erasable ink and a non-erasable ink; eradicating instruments; and systems comprising same.

### CROSS-REFERENCE TO RELATED APPLICATIONS

This application claims the benefit of U.S. Provisional Application No. 62/037,161, filed on Aug. 14, 2014. The disclosure of the above application is incorporated herein by reference.

### BACKGROUND

Non-erasable markers are typically used in home, classroom or office environments for various marking purposes. Non-erasable markers allow a user to mark indicia on various substrates without the risk of the markings being smudged or accidentally erased. Non-erasable markers can also be used to mark on various items which cannot be written upon by other writing instruments.

Non-erasable markers may be advantageous in that the risk of smudging the markings is minimized once the ink has dried, thereby minimizing the risk of transference of ink to items and persons that come into contact with the markings. However, a disadvantage of non-erasable markers is that the markings cannot easily be erased and/or corrected. In addition, commercially available editing/correction tools do not include a combination of erasable and non-erasable inks in a single instrument, requiring the user to search for, find and retrieve separate marking instruments to write over erased text.

Accordingly, there is a need for marking systems that can dispense erasable/correctable ink and a non-erasable ink from a single instrument. Embodiments of the present invention are directed to meetings these needs.

### BRIEF SUMMARY

In some embodiments, the present invention provides a marking instrument comprising: a housing; a first marking portion; and a second marking portion; wherein the first marking portion is configured to dispense an erasable ink; and the second marking portion is configured to dispense a non-erasable ink.

In other embodiments, the present invention provides a marking system comprising: a marking instrument having a first marking portion configured to dispense an erasable ink and a second marking portion configured to dispense a non-erasable ink; and an eradicating instrument.

Further embodiments provide a kit comprising a plurality of marking instruments described herein; an eradicating instrument as described herein; and instructions for use.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevational view of an exemplary marking instrument of the present invention.

FIG. 2 is a side elevational view in partial cross section of an exemplary marking instrument of the present invention.

FIG. 3 is a side elevational view of an exemplary eradicating instrument of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

According to the present invention the terms “about” and “substantially” refer to a +/−3% value.

In some embodiments, the present invention provides a marking instrument comprising: a housing; a first marking portion; and a second marking portion; wherein the first marking portion is configured to dispense an erasable ink; and the second marking portion is configured to dispense a non-erasable ink.

In some embodiments, the erasable ink is a water-based ink. In some embodiments, the non-erasable ink is an alcohol-based ink. In some embodiments, the water-based ink contains a pH sensitive colorant. In some embodiments, the alcohol-based ink contains a pH sensitive colorant. In some embodiments, the erasable ink is visible at low pH and invisible at high pH. In other embodiments, the non-erasable ink is visible at low pH and invisible at high pH. In some embodiments, the erasable ink is visible at high pH and invisible at low pH. In other embodiments, the non-erasable ink is visible at high pH and invisible at low pH.

In some embodiments, the erasable ink comprises a first color having a first color value (ΔE₁). In some embodiments, the non-erasable ink comprises a second color having a second color value (ΔE₂). In some embodiments, the first and second colors are substantially the same. In some embodiments, the first and second colors are identical.

In some embodiments, the first color and second color may each be black, and the first color value ΔE₁ and the second color value ΔE₂ may each range from about 3.0 to about 4.5—including all sub-ranges there-between. In a preferred embodiment, for black colors, the first and second color values ΔE₁ΔE₁ may each independently range from 3.1 to about 4.0—including all sub-ranges there-between.

In some embodiments, the first color and second color may each be red, and the first color value ΔE₁ and the second color value ΔE₂ may each range from about 9.0 to about 11.0—including all sub-ranges there-between. In a preferred embodiment, for red colors, the first and second color values ΔE₁ΔE₁ may each independently range from 9.1 to about 10.5—including all sub-ranges there-between.

In some embodiments, the first color and second color may each be blue, and the first color value ΔE₁ and the second color value ΔE₂ may each range from about 9.7 to about 13.7—including all sub-ranges there-between. In a preferred embodiment, for blue colors, the first and second color values ΔE₁ΔE₁ may each independently range from 10.0 to about 11.7—including all sub-ranges there-between.

The difference between the first color value ΔE₁ and the second color value ΔE₂ may be less than a color difference value V_{CD}.

ΔE₂−ΔE₁=V_{CD}

In some embodiments, the color difference value V_{CD} is less than about 4. In some embodiments, the color difference value V_{CD} is less than about 3. In some embodiments, the color difference value V_{CD} is less than about 2.5, preferably less than 2.3. In some embodiments, the color difference value V_{CD} is less than about 2. In some embodiments, the color difference value V_{CD} is less than about 1.5, alternatively less than 1.2. In some embodiments, the color difference value V_{CD} is less than about 1. In some embodiments, the color difference value V_{CD} is less than about 0.9, preferably less than 0.8, preferably less than 0.7. In some embodiments, the color difference value V_{CD} is less than 0.5.

In some embodiments, the average of the first color value ΔE₁ and the second color value ΔE₁ is less than 20. In some embodiments, the average of the first color value ΔE₁ and the second color value ΔE₁ is less than 15. In some embodiments, the average of the first color value ΔE₁ and the second color value ΔE₁ is less than 10. In some embodiments, the average of the first color value ΔE₁ and the second color value ΔE₁ is less than 7.5. In some embodiments, the average of the first color value ΔE₁ and the second color value ΔE₁ is less than 5. In some embodiments, the average of the first color value ΔE₁ and the second color value ΔE₁ is less than 4.

In some embodiments, the difference between the first color and the second color is not perceivable to the naked eye from a distance of 20 meters. In some embodiments, the difference between the first color and the second color is not perceivable to the naked eye from a distance of 15 meters. In some embodiments, the difference between the first color and the second color is not perceivable to the naked eye from a distance of 10 meters. In some embodiments, the difference between the first color and the second color is not perceivable to the naked eye from a distance of 5 meters. In other embodiments, the difference between the first color and the second color is not perceivable to the naked eye from a distance of 1 meter.

In some embodiments, the first marking portion is located at a first end of said housing and the second marking portion is located at a second end of said housing. In some embodiments, the first end and second end of said housing are opposing ends of said housing.

In some embodiments, the housing comprises a first reservoir and a second reservoir. In some embodiments, the first reservoir is configured to store the erasable ink and the second reservoir is configured to store the non-erasable ink.

In some embodiments, the second marking portion is wider than the first marking portion.

In further embodiments, the first marking portion comprises a wick. In other embodiments, the second marking portion comprises a wick.

In some embodiments, the wick of the first marking portion is in direct fluid communication with the first reservoir. In some embodiments, the wick of the second marking portion is in direct fluid communication with the second reservoir.

In some embodiments, the first marking portion is in fluid communication with the first reservoir. In some embodiments, the second marking portion is in fluid communication with the second reservoir.

Yet further embodiments provide a marking system comprising: a marking instrument having a first marking portion configured to dispense an erasable ink and a second marking portion configured to dispense a non-erasable ink; and an eradicating instrument.

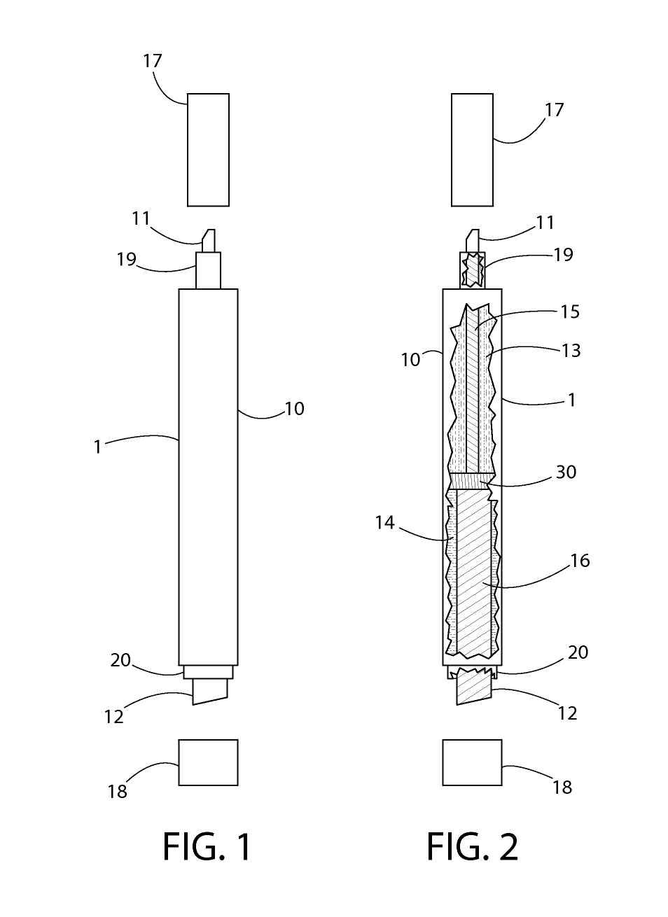

As shown in FIGS. 1 and 2, marking instrument 1 has a housing 10 having a first marking portion 11 which is configured to dispense an erasable ink, and a second marking portion 12 which is configured to dispense a non-erasable ink. The first marking portion 11 and second marking portion 12 are coaxially and opposingly located at a first end 19 and a second end 20 of housing 10.

The marking instrument 1 may be used with marking ink, highlighting ink, paint, or other suitable erasable ink.

In some embodiments, housing 10 is designed for manual gripping. An erasable ink contained in first reservoir 13 is dispensed from first marking portion 11 through wick 15, which may comprise felt or other suitable material. The opposingly located second marking portion 12 is configured to dispense a non-erasable ink contained in reservoir 14, through wick 16.

The housing 10 has wall 30, which separates the first reservoir 13 containing the erasable ink and the second reservoir 14 containing the non-erasable ink. The wall 30 extends internally to and transversely across the housing 10 and segregates the erasable ink from the non-erasable ink and defines the erasable ink reservoir 13 and non-erasable ink reservoir 14.

The first marking portion 11 and the opposingly located second marking portion 12, respectively have removable air tight caps 17, 18.

The housing 10 has opposing reciprocal collar ends 19 and 20, located adjacent the first marking portion 11 and second marking portion 12, respectively. Each of the caps 17 and 18 engages the respective reciprocal collar ends 19 and 20 of the housing 10 and provides substantially air tight closure of the first marking portion 11 and the second marking portion 12 from external environments, when the first marking portion 11 and second marking portion 12 of the marking instrument 1 are not in use.

The respective end caps 17 and 18 are removed from the respective reciprocal collar ends 19 and 20 of the first marking portion 11 and second marking portion 12 of marking instrument 1 when the respective first marking portion 11 and second marking portion 12 are in use, either individually or both.

The reciprocal collar ends 19 and 20 each have cross sectional diameters smaller than cross sectional diameter of the housing 10.

In some embodiments, housing 10 of the marking instrument 1 may have annular gripping cushions of rubber, foam or other suitable material, such as a malleable cushion of a flexible polymer, which conforms to the contours of the fingers of the user.

In some embodiments, second marking portion 12 is wider than first marking portion 11, so that when the user applies the non-erasable ink from marking portion 12, the non-erasable ink will leave a wider swath over the eradicated erasable ink dispensed from the first marking portion 11.

Marking instrument 1 may be made of metal, thermoplastic, thermosetting polymer, rubber, or other suitable material or combination thereof.

The erasable ink dispensed from the first marking portion 11 may be a conventional liquid ink, such as described, for example, in U.S. Pat. No. 6,149,721 (Wang, et al.) or other suitable liquid inks.

Further, the non-erasable ink dispensed from the second marking portion 12 is a solution which is capable of writing over a portion of a substrate from which erasable ink dispensed from the first marking portion 11, has been eradicated. The non-erasable ink renders the existence of the erasable ink unascertainable.

In some embodiments, the systems of the present invention comprise an eradicating instrument which is configured to dispense an eradicator composition. In some embodiments, the eradicator composition comprises a bleach, such as a hypochlorite, among others, as described in U.S. Pat. No. 5,427,278 (Gardner) or another suitable eradicator composition.

In some embodiments, the eradicator composition comprises a neutralizing agent. While intending not to be bound by theory, the present inventors believe that in those embodiments wherein the eradicator composition contains a neutralizing agent, the neutralizing agent interacts with the erasable ink at a molecular level.

Some embodiments of the present invention provide a kit comprising any one of the marking instruments described herein; an eradicating instrument; and instructions for use.

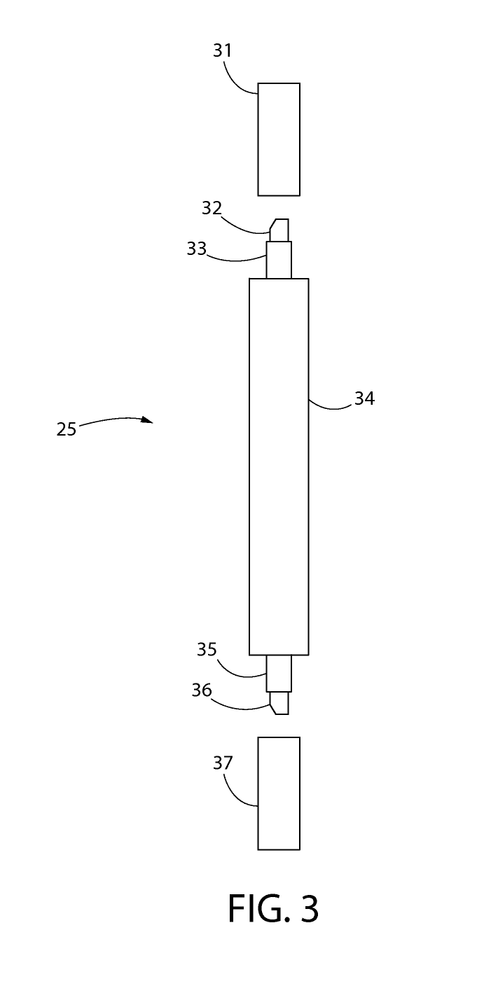

As shown in FIG. 3, eradicating instrument 25 comprises a housing 34; a first eradicating portion 32 for dispensing a first eradicating composition, a second eradicating portion 36 for dispensing a second eradicating composition; end caps 31, 37; and collars 33, 35. The eradicator instrument housing 34 has opposing reciprocal collar ends 33 and 35, located adjacent the first eradicating portion 32 and second marking portion 36, respectively. Each of the caps 31 and 37 engage the respective reciprocal collar ends 33 and 35 of the eradicating instrument housing 34 and provides substantially air tight closure of the first eradicating portion 32 and the second eradicating portion 36 from external environments, when the first eradicating portion 32 and second eradicating portion 36 of the eradicating instrument 25 are not in use. The respective end caps 31 and 37 are removed from the respective reciprocal collar ends 33 and 35 of the first eradicating portion 32 and second eradicating portion 36 of eradicating instrument 25 when the respective first eradicating portion 32 and second eradicating portion 36 are in use, either individually or both. The reciprocal collar ends 33 and 35 of the eradicating instrument each have cross sectional diameters smaller than cross sectional diameter of the housing 34.

In some embodiments, housing 34 of the eradicating instrument 25 may have annular gripping cushions of rubber, foam or other suitable material, such as a malleable cushion of a flexible polymer, which conforms to the contours of the fingers of the user.

In some embodiments, the marking instrument comprises one or more valves for permitting/restricting the flow of the erasable and/or non-erasable inks.

In some embodiments, the eradicating instrument comprises one or more valves for permitting/restricting the flow of the eradicating composition.

In some embodiments, the first marking portion comprises a nib. In some embodiments, the second marking portion comprises a nib. In some embodiments, the first eradicating portion comprises a nib. In some embodiments, the second eradicating portion comprises a nib.

In some embodiments, the marking instrument comprises one or more ferrules which reinforce the first and/or second marking portions.

Other embodiments of the present invention provide a kit comprising a plurality of marking instruments; one or more eradicating instruments; and instructions for use. In some embodiments, the kits of the present invention comprise a marking instrument as shown in FIGS. 1 and 2; an eradicating instrument as shown in FIG. 3; and instructions for use. In some embodiments, the kit comprises a plurality of marking instruments having first and second marking portions, wherein the first and second marking portions of each marking instrument are of a different color from the first and second marking portions of the other marking instruments in the kit. In some embodiments, the first and second marking portions of a particular marking instrument are of substantially the same color. In some embodiments, the eradicating instrument has at least one eradicating portion that is wider than the first marking portion. In some embodiments, at least one eradicating portion is wider than a first marking portion and narrower than a second marking portion.

Some embodiments provide a method of editing a document comprising dispensing an eradicating composition from an eradicating instrument to a document containing text in an erasable ink; and dispensing a non-erasable ink from any one of the marking instruments described herein to the eradicated portion of the document. In some embodiments, a user will not be able to recognize the corrected text.

Some embodiments of the present invention solve the problem of having to search for, find and retrieve separate marking instruments for dispensing erasable and non-erasable inks, since the first marking portion and second marking portion of the marking instrument are all-inclusive and have both functions in one, single, convenient marking instrument.

The invention will be described in greater detail by way of a specific example. The following example is offered for illustrative purposes and is not intended to limit the invention in any manner.

### EXAMPLES

Color differences between erasable and non-erasable inks are evaluated. Drawdowns of ink are made on the back side of heavyweight white poster board using a 0 blade. Color measurements are made one (1) hour after drying using an X-Rite 530 SpectroDensitometer. Color differences are measured using either the erasable ink or non-erasable ink as a reference color. For example, erasable red ink samples are evaluated against non-erasable red ink samples, and vice versa.

Samples are evaluated using the CIEL*a*b* color measurement method, wherein L* represents the difference between light (where L*=100) and dark (where L*=0); A* represents the difference between green (−a*) and red (+a*); and b* represents the difference between yellow (+b*) and blue (−b*). Variables of L*, a*, or b* are represented as delta L*, delta a*, or delta b*. Delta E*=delta (delta L*²+delta a*²+delta b*²), and represents the magnitude of a difference in color, without indicating the direction of the color difference.

### Example 1

Six drawdowns were prepared—three being an erasable black ink and three being a non-erasable black ink. Delta E* for each of the drawdowns were measured. The Delta E* value for the three erasable black inks were averaged together and the Delta E* for the three non-erasable black inks were averaged together. The resulting Delta E* values of the erasable and non-erasable inks are presented below in Table 1:

TABLE 1

| Black Color | Δ E |
|---|---|
| Erasable Ink | 3.89 |
| Non-Erasable Ink | 3.27 |
| Difference in Δ E Between | 0.62 |
| Erasable and Non-Erasable Ink | |

### Example 2

The process of Example 1 was repeated except for now for red inks.

TABLE 2

| Red Color | Δ E |
|---|---|
| Erasable Ink | 10.07 |
| Non-Erasable Ink | 10.76 |
| Difference in Δ E Between | 0.69 |
| Erasable and Non-Erasable Ink | |

### Example 3

The process of Example 1 was repeated except for now for red inks.

TABLE 3

| Blue Color | Δ E |
|---|---|
| Erasable Ink | 11.23 |
| Non-Erasable Ink | 10.06 |
| Difference in Δ E Between | 1.17 |
| Erasable and Non-Erasable Ink | |

### Example 4

Using the Delta E* color values obtained in Examples 1-3, the average Delta E* value was able to be calculated for each color, as set forth below in Table 4.

TABLE 4

| Color | Average Δ E |
|---|---|
| Black | 3.58 |
| Red | 10.41 |
| Blue | 9.22 |

It is intended that any patents, patent applications or printed publications, including books, mentioned in this patent document be hereby incorporated by reference in their entirety.

As those skilled in the art will appreciate, numerous changes and modifications may be made to the embodiments described herein, without departing from the spirit of the invention. It is intended that all such variations fall within the scope of the invention.

What is claimed is:

1. A marking instrument comprising:
a housing;
a first marking portion; and
a second marking portion;
wherein the first marking portion is configured to dispense an erasable ink; and the second marking portion is configured to dispense a non-erasable ink.

2. The instrument of claim 1, wherein the erasable ink comprises a first color having a first color value as measured by ΔE.

3. The instrument of claim 1, wherein the non-erasable ink comprises a second color having a second color value as measured by ΔE.

4. The instrument of claim 3, wherein the difference between the first color value and the second color value is less than 2.

5. The instrument of claim 4, wherein the difference between the first color value and the second color value is less than 1.

6. The instrument of claim 3, wherein the first color is red and the second color is red.

7. The instrument of claim 3, wherein the first color is black and the second color is black.

8. The instrument of claim 3, wherein the first color is blue and the second color is blue.

9. The instrument of claim 1, wherein the first marking portion is located at a first end of said housing and the second marking portion is located at a second end of said housing.

10. The instrument of claim 1, wherein the housing comprises a first reservoir and a second reservoir.

11. The instrument of claim 10, wherein the first reservoir is configured to store the erasable ink and the second reservoir is configured to store the non-erasable ink.

12. The instrument of claim 1, wherein the second marking portion is wider than the first marking portion.

13. The instrument of claim 1, wherein the first marking portion comprises a wick.

14. The instrument of claim 1, wherein the second marking portion comprises a wick.

15. The instrument of claim 13, wherein the wick of the first marking portion is in fluid communication with the first reservoir.

16. The instrument of claim 14, wherein the wick of the second marking portion is in fluid communication with the second reservoir.

17. A marking system comprising:
a marking instrument having a first marking portion and a second marking portion; and
an eradicating instrument;
wherein the first marking portion is configured to dispense an erasable ink and the second marking portion is configured to dispense a non-erasable ink.

18. The system of claim 17, wherein the erasable ink has a first color value as measured by ΔE and the non-erasable ink has a second color value as measured by ΔE, wherein the difference between the first color value and the second color value is less than 2.

19. The system of claim 17, wherein the eradicating instrument contains an eradicating composition.

20. The system of claim 19, wherein the eradicating composition comprises a neutralizing agent.
